(19) United States
(12) Patent Application Publication
(10) Pub. No.: US 2023/0082491 A1
(43) Pub. Date: Mar. 16, 2023

(54) SYSTEMS, APPARATUS, AND METHODS USEFUL FOR TRANSPARENT COMPUTERIZED EMPLOYER AND RECRUITMENT CANDIDATE MATCHING AND NEGOTIATION

(71) Applicant: Paul DIAZ, Rockville, MD (US)

(72) Inventor: Paul DIAZ, Rockville, MD (US)

(21) Appl. No.: 17/194,259

(22) Filed: Mar. 6, 2021

Related U.S. Application Data
(60) Provisional application No. 62/986,622, filed on Mar. 6, 2020.

(51) Int. Cl. G06Q 10/10

(52) U.S. Cl. CPC G06Q 10/1053

(57) ABSTRACT

A computerized system useful for machine based matching of job candidates to hiring party requirements includes a processor associated with a central server configured for networked communication with remotely located user devices; a hiring party profile database; a hiring party profile module; a candidate profile database; a candidate profile modules; and a match module configured to match job candidates based on candidate profile information electronically stored in the candidate profile database.

### FIELD

The disclosure relates to systems, apparatus, and methods useful for machine applied recruitment. In particular, the disclosure relates to computerized systems and apparatus, and computerized methods useful for matching candidate employees or contractor agents with employers or principals and semi-automated negotiation.

### BACKGROUND

Conventional recruiting processes for hiring skilled talent are costly, time-consuming, inefficient, and unpredictable. Conventional recruiting processes favor employers or hiring principals by focusing service on the hiring party. For example, typically, a hiring party posts a job position on one or more various job boards, print media outlets, and/or other services or forums designed to facilitate job availability advertising. A hiring party may “source,” or search for candidates using tools and products designed to assist recruiters in searching.

When a potential candidate is found by these collection and search methods, a recruiter typically conducts an initial screen of the candidates qualifications to determine whether the candidate is a match for the position to be filled. The initial screen may be a detailed review of additional information about the candidate, or an interview with the candidate. If a potential candidate is determined to be a match to the position to be filled, then the hiring party may interview the candidate and/or discuss the candidate with and/or introduce the candidate to other members of the hiring party organization. Such interviews and/or meetings may take place in person, and may require travel and significant schedule coordination between participating parties.

If the hiring party then determines to extend an offer of employment or to hire the potential candidate, the hiring party may issues an offer, which includes the compensation that the hiring party is willing to pay. If the candidate determines that the offer is low, the candidate may counter and the parties may negotiate. If an agreement is not reached, the process ends and the parties must begin anew.

New graduates or those uncomfortable with the interview process may find this conventional process intimidating, especially negotiating salary. Many newer job seekers accept offers at a rate lower than their actual worth with in the job market due to intimidation, inexperience at interviewing, and/or uncertainty about worth or value in the job market. Indeed, the above-described process is arduous and unpredictable from the job seeker's perspective. For example, conventionally, the job seeker finds an advertised position and submits a lengthy written application. The candidate must then await, and if selected, participate in a screening interview. In some circumstances, candidates must participate in more than one interview, and may need to travel to one or more locations to do so. The candidate may then endure an uncertain waiting process, all well before understanding the hiring party's position on compensation with respect to the candidate.

### SUMMARY

While the hiring party enjoys a position of leverage in conventional recruiting methods, the hiring party also suffers from inefficiency, unpredictability, and necessary costs only to find in the end that the candidates compensation expectations do not align with those of the hiring party. Accordingly, a need exists to solve and address these problems, thereby enhancing efficacy and efficiency of the hiring process for all interested parties.

Systems, apparatus, and machine-implemented methods disclosed herein meet this need. In embodiments, the candidate search and selection process is computerized and machine-implemented. A central server receives, stores, and maintains data including candidate-entered information and hiring party-entered information. The candidate information and the hiring party information may be received at the central server by electronically formatted communications processed by a communications module. Any suitable combination of computer(s) and wired and wireless communications method(s), device(s), and system(s), now known or later developed, may be used within the scope and spirit of the embodiments of the disclosure. The candidate and/or hiring party may submit data to the central server by way of a geographically remotely located computing devices such as a personal desktop computer or laptop, tablet computer, smartphone, or other similar computing device having telecommunications or networking capability.

The candidate user device and the hiring party user device may be configured to cause a processor of the user device to run a software application that serves to receive user-input information at the user device, and to communicate a message including this information to the remotely located central server. Accordingly, in an embodiment, a processor of the candidate device or the hiring party device causes the mobile device to display or otherwise prompt the user to input information in response to a user running the software application.

For example, the candidate device or the hiring party device is configured to cause the user to complete a user profile by prompting the user to input data to the device. The candidate device or hiring device automatically sends the input data to the central server by electronic communication. The user profile is stored in a candidate profile database or a hiring party database. User profile information includes biographical data, licenses and/or certifications, experience, geographic location, and other information useful to matching a potential job candidate with an employer and/or matching a potential employer with a candidate.

In embodiments, the candidate device is configured to invite the user to enter a desired compensation, geographic preference and other compensation/benefit related information normally found in a standard employment offer. In exemplary embodiments, the candidate device is configured to run the software application to match the candidate to an employer user of the system seeking potential job candidates. The candidate device and/or central server is/are configured to determine the match based on the user profile information, including the compensation information and the geographic location information. In embodiments, the user device is configured to communicate a match to the user based on result of processing the profile information. For example, a controller at the user device and/or the central server may cause a profile information processing module to match a potential job candidate to an employer by comparing profile attributes including the above-mentioned profile information types with pre-determined thresholds. Any suitable matching algorithm determined by now known and later developed methods is implemented that provides candidates to seeking hiring parties. The algorithm is configured to determine a match or degree of match between candidate(s) and a hiring party based on candidate profile information and hiring party profile information, and to select one or more candidates based on the determined match.

The hiring party may be prompted by the hiring party user device to enter hiring party profile information, including hiring party candidate attribute preference information. In a preferred embodiment, the hiring party candidate attribute preference information includes candidate geographical location of residence or preference, compensation requirements, and any other information useful for screening job candidates.

In an embodiment of systems, a computerized system useful for machine based matching of job candidates to hiring party requirements includes a processor associated with a central server configured for networked communication with remotely located user devices; a hiring party profile database; a hiring party profile module; a candidate profile database; a candidate profile modules; and a match module configured to match job candidates based on candidate profile information electronically stored in the candidate profile database.

In another embodiment, a first candidate profile information is stored in the candidate profile database, and a second candidate profile information is stored in the candidate profile database. In an embodiment, the candidate profile information includes compensation information input by a candidate user at a first remotely located user device, and electronically formatted and communicated to the central server, wherein the candidate profile module automatically processes the electronically formatted and communicated compensation information and stores said automatically processed compensation information in the candidate profile database.

In an embodiment, the candidate profile information includes compensation information input by a candidate user at a second remotely located user device, and electronically formatted and communicated to the central server, wherein the candidate profile module automatically processes the electronically formatted and communicated compensation information and stores said automatically processed compensation information in the candidate profile database.

In embodiment, the match module is configured to match the first candidate user based on hiring party information electronically communicated from a hiring party user device by the central server and automatically processed by the processor and the hiring party profile module and stored in the hiring party profile database.

In an embodiment, the hiring party profile module further comprising being configured to automatically, with the processor, extract hiring party profile information from an electronically formatted communication from a hiring party user device received by the central server. In an embodiment, the hiring party profile information includes compensation requirements or target compensation parameters.

In an embodiment, the match module is configured to match a candidate user by processing, using the processor, the stored candidate profile information and the stored hiring party profile information to determine a match for the candidate and hiring party. In an embodiment, the match module is configured to match a candidate user to a hiring party by processing, using the processor, the stored candidate profile information and the stored hiring party profile information to determine the degree to which the candidate and the hiring party profiles match.

In an embodiment, the central server and the match module is configured to select and electronically communicate candidate information based on candidate match information stored in the match database.

In an embodiment, systems include a negotiation module configured to determine an initial, system recommended, compensation offer for the hiring party to transmit to the candidate based on the compensation parameters entered by the candidate and hiring party using the system. The hiring party may accept or adjust the system recommended offer prior to submitting it, wherein the negotiation module causes electronic communication of the proposed compensation offer to the candidate user device or the hiring party user device for display thereon. The candidate may then accept the proposed offer, decline the proposed offer or adjust any component of the offer (thereby issuing a counter-offer to the hiring party) causing electronic communication of the candidate's response to the hiring party user device for display thereon. The hiring party may then accept the candidate's counter-offer or make another counter-offer causing electronic communication of the hiring party's response to the candidate user device for display thereon. The candidate may then accept or decline the final offer thereby ending the negotiation process causing electronic communication of the candidate's response to the hiring party's user device for display thereon.

In embodiment of methods, useful for machine based matching of job candidates to hiring party requirements, processes include providing a user input portal a job candidate user device configured to communicate with a central server; receiving at the central server an electronic communication from the candidate user device; automatically processing the electronic communication using a processor and a candidate profile module to extract user profile information, the user profile information comprising compensation information; automatically electronically storing the extracted user profile information comprising the compensation information and optionally other job specific requirements in a candidate profile database; and comparing the user profile information comprising the compensation information with hiring party profile information, the hiring party profile information comprising target compensation requirement(s), to match the candidate associated with the user profile information to the hiring party based on the hiring party profile information.

In an embodiment, methods include electronically storing the determined match in a match database using the processor and the match module. In an embodiment, methods include electronically communicating the determined match stored in the match database to a hiring party user device from the central server. In another embodiment, methods include receiving at the central server hiring party profile information, the hiring party profile information comprising target compensation requirements for comparing with compensation information of a stored candidate user profile information.

In an embodiment, methods include receiving at the central server a second candidate user profile information electronically communicated from a second candidate user device. In an embodiment, methods include automatically processing the second candidate user profile information communicated from the second candidate user device using the processor and the candidate user profile module.

In an embodiment, methods include the candidate user profile information further including geographic location information corresponding to residence or work location. In an embodiment, the hiring party user profile information includes geographical location requirements, such as location of residence and/or required location of work.

In an embodiment, methods include determining, using a negotiation module and the processor, a proposed compensation offer or counter-offer by a hiring party or by a candidate using the system, wherein the negotiation module caused electronic communication of the proposed compensation offer to the candidate user device or the hiring party user device for display thereon, wherein the proposed compensation offer is based on at least one factor selected from the group including: hiring party hiring requirements, candidate compensation requirements, third party compensation information located at third party databases, additional information retrieved from local area networked database; and electronically communicating the proposed compensation offer to the candidate user device or the hiring party user device.

Additional features and technical effects of the present disclosure will become readily apparent to those skilled in the art from the following detailed description wherein embodiments of the present disclosure are described simply by way of illustration of the best mode contemplated to carry out the present disclosure. In addition to the embodiments disclosed herein, other and different embodiments are within the spirit and scope of the disclosure, and its several details are capable of modifications in various respects.

### BRIEF DESCRIPTION OF DRAWINGS

The disclosure is shown by way of example in the figures of the accompanying drawings, in which like reference numerals refer to like elements.

FIG. 1 shows a diagrammatical plan view of systems in accordance with an exemplary embodiment;

FIG. 2 shows machine-based methods in accordance with an exemplary embodiment;

FIG. 3 shows machine-based methods in accordance with an exemplary embodiment;

FIG. 4 shows Candidate Profile Information in an accordance with an exemplary embodiment;

FIG. 5 shows Hiring Party Profile Information in accordance with an exemplary embodiment;

### DETAILED DESCRIPTION

Exemplary embodiments are intended to cover all alternatives, modifications, and equivalents as may be included within the spirit and scope of the systems, apparatus, and methods as described herein.

Reference is made to the drawings to accommodate understanding of systems for teledining in accordance with systems, apparatus, and methods of embodiments. In the drawings, like reference numerals are used throughout to designate similar or identical elements. The drawings depict various embodiments of illustrative systems, apparatus, and methods for candidate-to-hiring party matching.

Computerized systems and apparatus, and computerized methods useful for matching candidate employees or contractor agents with employers or principals are provided. Embodiments of systems, apparatus, and methods are disclosed herein.

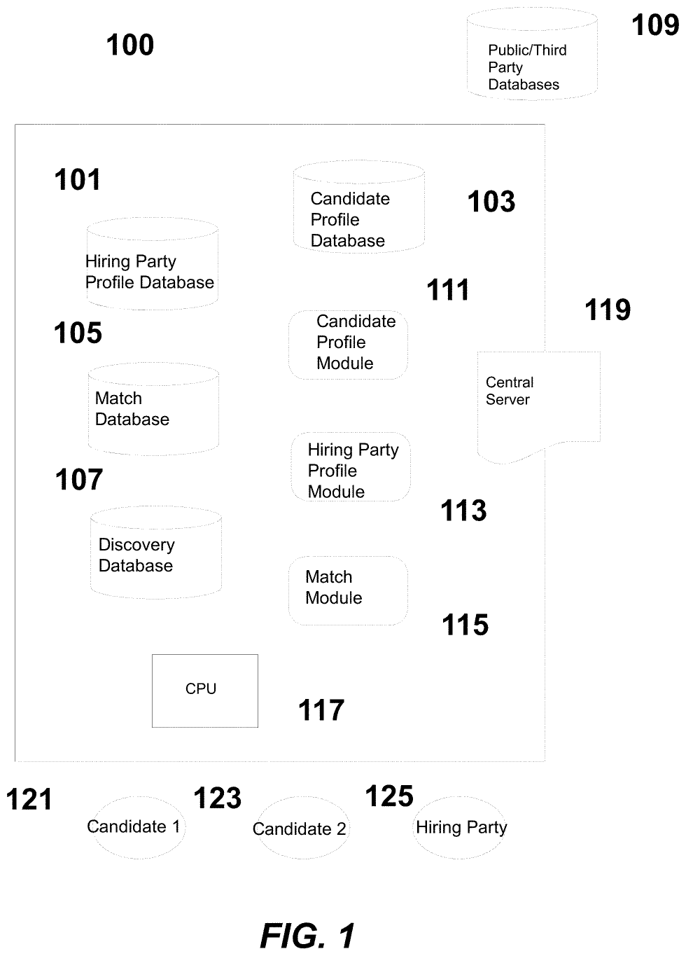

FIG. 1 shows a computerized system 100 for machine-based matching of candidate employees or contractor agents with hiring party employers or principals. In particular, the system 100 includes a hiring party database 101, a candidate profile database 103, a match database 105, a discovery database 107, and a third party database 109. In an embodiment, the database(s) are one or more memory storage devices or systems formed of any suitable now know or later developed components and methods. Individual system components such as memory storage devices, controllers or processors, communications interfaces, receivers, transceivers, and the like are known. Although, later developed system components may be implemented for forming systems while in accordance with embodiments and the scope and spirit of the disclosure.

The hiring party profile database 101 is configured for storing hiring party information harvested from a hiring party user of the system at a user device. The candidate profile database 103 is configured for storing candidate profile information harvested from a potential job candidate or job searcher user of the system.

The match database 105 is configured for storing match information corresponding to candidate user identities and/or hiring party user identities. The matching is performed by the match module 115 of the system 100 in accordance with an algorithm or computer readable instructions using one or more processors. The match data is electronically formatted and electronically stored according to, and using, any suitable now known or later developed methods and protocols. The match data is useful for matching the candidates to employers or hiring parties and is produced by matching candidate profile information, including compensation information and in some embodiments, geographic location information, against hiring party-provided match criteria. For example, a hiring party-provided criteria may include pre-determined compensation requirements, and in some embodiments, geographic location information. The hiring party or candidate-provided criteria may include a first match threshold of 80%, for example, whereby the match data stored in the match database includes candidates and hiring parties identified as an 80% or better match to the requirements set by the hiring party or candidate. 80% is only one example of a first match threshold that may be set by the hiring party or candidate.

The discovery database 107 is configured for storing match data corresponding to matched candidate or hiring party user(s) that fall below a pre-determined match threshold provided by a hiring party or candidate. In another embodiment, the match data corresponds to matched candidate or hiring party user(s) that meet a second match threshold pre-determined by the hiring party user. For example, in an embodiment, the hiring party may electronically communicate a second match threshold of 60% to the system 100. The system may be configured to match and store candidate identities that meet the second match threshold, but not the first match threshold. The percentage values provided herein are merely example threshold match values.

The system 100 includes a candidate profile module 111, e.g., including computer readable instructions for processing candidate profile information, a hiring party profile module 113, and a match module 115. One or more processors or controller(s) 117 causes the modules to execute processes for populating the corresponding hiring party profile database 101, match database 105, and discovery database 107.

The electronic databases and application modules may be associated with a central server 119. The central server 119 may be configured to receive and send electronically formatted communications transmitted over telecommunications networks or any wired and/or wireless communications network. The system 100 may include or may be configured to work with network components operably connected networked systems and devices using wired or wireless connections, local area and/or wide area networks, or a combination thereof.

The system 100 includes the central server 119 networked to user devices. In particular, candidate and/or hiring party user devices may include an electronic display device such as a tablet computing device, mobile smart phone device, stationary or mobile personal computer and display systems, or any combination of the myriad of components now available or are later developed for enabling network communication, processing of user inputs by way of an input device such as a keyboard or touch screen display, and display to a user of data, which data may include locally generated data, and data received at the device from a remote device connected to by one or more wired and/or wireless local area and/or wide area networks.

FIG. 1 shows a first candidate user device and a second candidate user device, each separately connected to the central server 119 by networked communications systems and methods of suitable type and availability, now known or later developed. For example, the first candidate user device 121 is in networked communication with the central server 119, and capable of being geographically remotely located.

Similarly, a second candidate user device 123 is in networked communication with the central server 119, and capable of being geographically remotely located from the central server 119, and the first candidate user device 121. The candidate user devices 121 and 123 are configured to receive user input information.

In particular, the user input information includes compensation information such as salary requirements or desired compensation for the candidate. The compensation may include monetary compensation, wages, bonuses, paid vacation, or any other aspect of compensation applicable for a particular sought position.

The user devices 121 and 123 may also receive other user input information including geographical location of residence or desired location of work. The user devices 121 and 123 are configured to communicate the user input information to the central server 119 for processing and storage and use in matching.

Accordingly, hiring parties may be presented at the outset with a candidate's compensation requirements, or presented with candidates that fall within a pre-determined accepted or intended compensation range set by the hiring party. Further, even more effective results are achieved by screening the candidates based on geographical location information.

A hiring party user device 125 is in networked communication with the central server 119, and capable of being geographically remotely located from the central server 119, the first candidate user device 121, and the second candidate user device 123. The hiring party user device 125 is configured to receive hiring party profile information for electronic communication to the central server 119 for automatic processing and electronic storage.

For example, the first and second user devices 121 and 123 may each communicate respective electronically formatted profile information to the central server 119. The information is processed by the candidate profile module 111, which is configured to automatically extract and store profile information in the candidate profile database 103. The stored profile information includes, at least, compensation information.

The hiring party user device 125 may communicate electronically formatted hiring party information to the central server 119 for processing by the hiring party profile module 113 and storage in the hiring party profile database 101. The hiring party profile information includes, at least, hiring requirements including pre-determined or target compensation to be paid to a hired party.

In some embodiments, the match module 115 compares the candidate compensation information to the hiring party target compensation to determine a match. The match module 115 stores the match in the match database 105 and/or a discovery database 107. The central server 119 may be configured to electronically communicate the match information to the hiring party user device 125 and/or candidate user device(s) 121 and 123.

In an embodiment, the match module 115 is configured to match candidates based on information stored in the hiring party profile database. In particular, the match module 115 is configured to compare candidate user profile information with pre-determined hiring party information, such as a hiring criteria threshold pre-set by the hiring party. For example, the hiring party may electronically communicate to the central server 119 a compensation range as part of a hiring criteria. This compensation range may be stored in the candidate user profile database 103 and used by the match module 115 as a first match threshold. Accordingly, the match module 115 compares candidate user profile data including input compensation requirements to determine whether the candidate compensation matches or is within the bounds of the first match threshold. The match module 115 stores the determined match in the match database 105. The central server may be configured to electronically communicate the match information to the hiring party user device 125 and/or the candidate user device(s) 121 and/or 123.

In an embodiment, the match module 115 is configured to selected candidates for presentation to a hiring party based on a determined match to a second pre-defined match criteria threshold. For example, the hiring party profile information may include a second match criteria threshold that is lower than the first match threshold. The match module 115 may be configured to match one or more candidates with the pre-determined second match threshold, and store the matches in a discovery database 107.

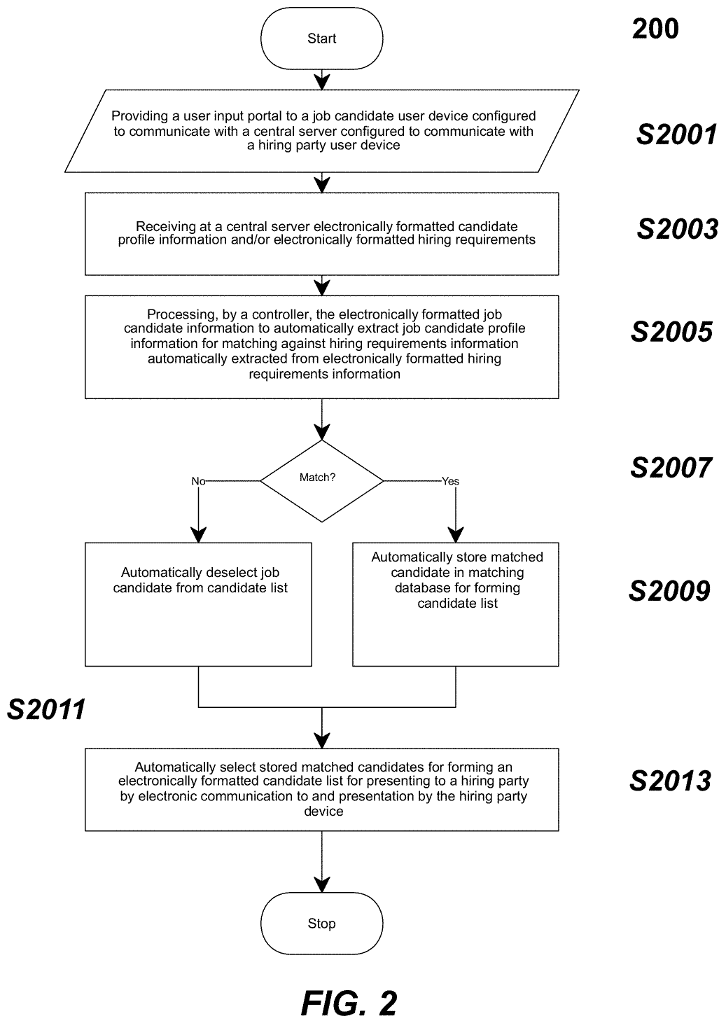

FIG. 2 shows processes for machine-based matching of job candidates with hiring party employers or principals. In particular, FIG. 2 shows a method 200. The method 200 may be implemented, for example, using the system 100 shown in FIG. 1.

FIG. 2 shows the method 200 includes a step S2001 of providing a user input portal to a job candidate user device. The job candidate user device is configured to communicate with a central server. The input portal is configured to receive user input at the candidate user device, including user profile information to be electronically communicated to the central server for processing and storage.

The method 200 includes a step S2003 of receiving at a central server electronically formatted candidate profile information. The candidate profile information is transmitted by the candidate user device. Alternatively, or in combination, the method 200 includes a S2003 of receiving at the central server electronically formatted hiring requirements. The hiring requirements are transmitted by a hiring party user device.

The method 200 includes a step S2005 of processing the electronically formatted job candidate information to automatically extract candidate profile information. The candidate profile information includes information useful for comparing against hiring party requirements. The candidate profile information includes compensation information input by the candidate associated with the candidate profile information. In other embodiments, the candidate profile information includes additional data such as geographical location of residence, or desired work location, name, mailing address, or other identifying information, or information useful for a job candidate profile.

The method 200 includes matching at S2007, using a processor and match module, user candidates based on stored candidate profile information compared with stored hiring criteria. In particular, the match module matches a candidate in view of stored hiring requirements of a hiring party. The match module automatically electronically stores the determined match in a match database. In an embodiment, the match module processes stored candidate profile information including compensation information with a hiring criteria threshold. The hiring criteria threshold may include a required compensation range, and in some embodiments, may also include required geographical locations. The match module may determine the extent to which the stored candidate profile information matches the hiring criteria threshold.

If either user is determined to match the other user's requirements at S2007 based at at a pre-determined threshold, the user's information is automatically stored in a match database at S2009. FIG. 2 shows that in some embodiments, a candidate is automatically not included in a candidate list if no match is found at the pre-determined threshold by the match module at S2011. Information for users that are not found to match at the pre-determined threshold are stored in a discovery database.

The candidate stored in the match database at S2009 may be identified and presented to a hiring party user by way of an electronically formatted communication between the central server and the hiring party user device at S2013. In some embodiments, the candidate stored in the discovery database may be identified and presented to a hiring party user by way of an electronically formatted communication between the central server and the hiring party user device. In embodiments, the match information stored the match database and/or discovery database may be electronically communicated to one or more respective candidate user devices to communicated matched employer leads.

The candidate or hiring party user device(s) may be caused to display or otherwise communicate the matches to a user, automatically, or on demand. In some embodiments, the user interface provided in the job candidate or hiring party user device is configured to provide an electronic information feed with updates pertaining to matches. For example, a user interface may be configured to display a feed showing candidate or employer matches to a a pre-determined threshold.

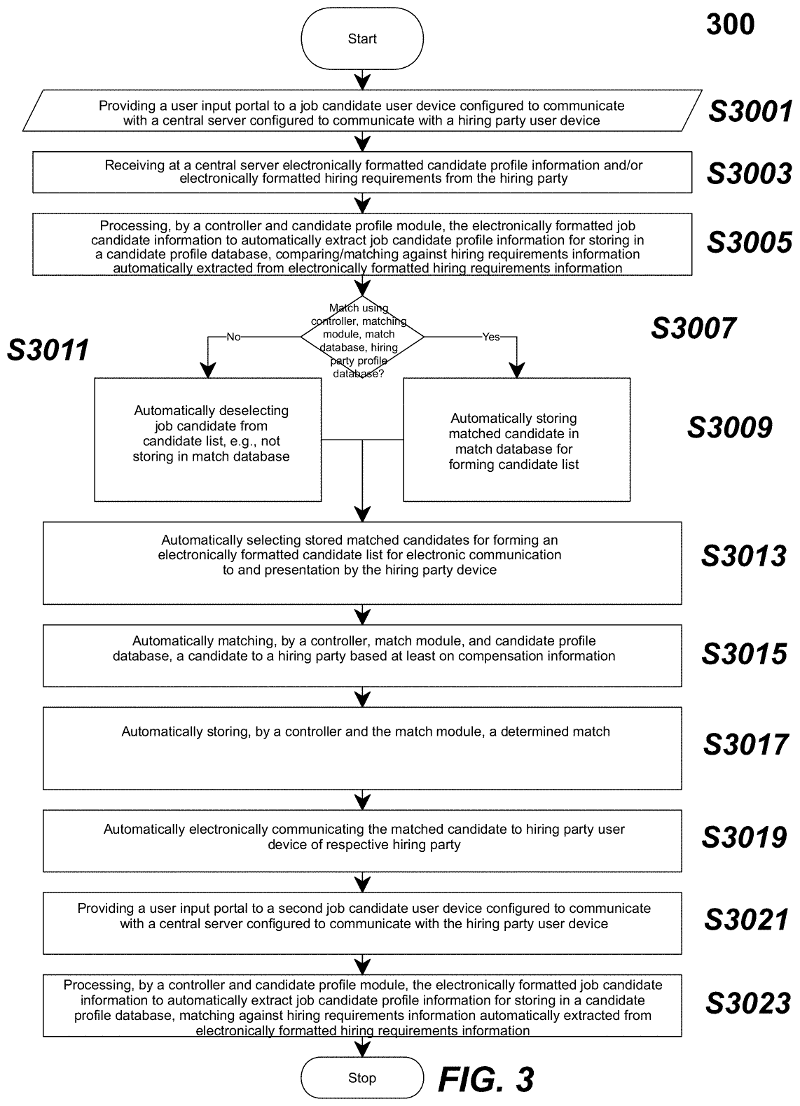

FIG. 3 shows processes for machine-based matching of candidates with hiring party employers or principals. In particular, FIG. 3 shows a method 300. The method 300 may be implemented, for example, using the system 100 shown in FIG. 1.

FIG. 3 shows the method 300 includes a step S3001 of providing a user input portal to a job candidate user device. The job candidate user device is configured to communicate with a central server. The input portal is configured to receive user input at the candidate user device, including user profile information to be electronically communicated to the central server for processing and storage.

The method 300 includes a step S3003 of receiving at a central server electronically formatted candidate profile information. The candidate profile information is transmitted by the candidate user device. Alternatively, or in combination, the method 300 includes a S3003 of receiving at the central server electronically formatted hiring requirements. The hiring requirements are transmitted by a hiring party user device.

The method 300 includes a step S3005 of processing the electronically formatted job candidate information to automatically extract candidate profile information using a processor and candidate profile module. The candidate profile information includes information useful for comparing against hiring party requirements. The candidate profile information includes compensation information input by the candidate associated with the candidate profile information. In other embodiments, the candidate profile information includes additional data such as geographical location of residence, or desired work location, name, mailing address, citizenship, social security number or other identifying information, or information useful for a job candidate profile. The candidate profile module stores the extracted information in the candidate profile database.

The method 300 includes matching at S3007, using a processor and match module, user candidates based on stored candidate profile information compared with stored hiring criteria. The stored candidate profile information includes, at least, compensation information. The compensation information, alone or in combination with other factors and information such as geographical location of residence are used to match the candidate to a hiring party. Preferably, both compensation information and geographical information are used for matching. In particular, the match module matches a candidate in view of stored hiring requirements of a hiring party. The match module automatically electronically stores the determined match in a match database. In an embodiment, the match module processes stored candidate profile information including compensation information with a hiring criteria threshold. The hiring criteria threshold may include a required compensation range, and in some embodiments, may also include required geographical locations. The match module may determine the extend to which the stored candidate profile information matches the hiring criteria threshold.

If a candidate is determined to match hiring party requirements at S3007 based, at least, on compensation, the candidate is automatically stored in a match database at S3009. FIG. 3 shows that in some embodiments, a candidate is automatically not included in a candidate list if no match is found by the match module at S3011. In some embodiments, at S3011, the match module processes candidate profile information to compare the candidate profile information against a second hiring criteria threshold based on the stored hiring party profile information. For example, the first threshold may include a compensation range with a lower limit higher than the second threshold compensation range. Candidates that are not found to match the first threshold at S3007, may be determined to meet the second threshold at S3011. Subsequently, the match module stores the second threshold match information in a discovery database.

The candidate stored in the match database at S3009 may be identified and presented to a hiring party user by way of an electronically formatted communication between the central server and the hiring party user device at S3013. In some embodiments, the candidate stored in the discovery database may be identified and presented to a hiring party user by way of an electronically formatted communication between the central server and the hiring party user device. In embodiments, the match information stored the match database and/or discovery database may be electronically communicated to one or more respective candidate user devices to communicated matched employer leads.

In an embodiment, method 300 includes a step S3021 of providing a user input portal to a second job candidate user device configured to communicate with a central server. The method 300 includes a step S3023 of processing, by a controller and candidate profile module, electronically formatted profile information for a second candidate user received in an electronic communication from the second job candidate user device. Candidate profile information for the second candidate is automatically extracted and stored in the candidate profile database.

The second candidate profile information includes, at least, compensation information. In some embodiments, the second candidate profile information includes geographic location information concerning a residence or desired location of work input by the second candidate. A match module may process the second candidate information in view of the hiring party information including compensation requirements and automatically determine a match of the second candidate information. The determined match may be automatically electronically stored in a match database. Alternatively, the determined match may be automatically electronically stored in a discovery database.

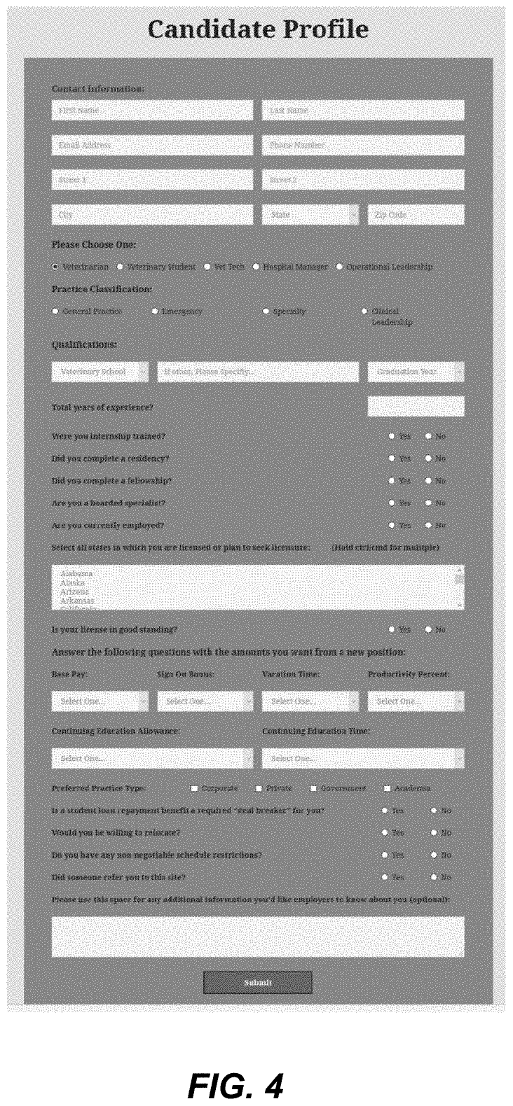

FIG. 4 shows a screenshot of a display at a candidate user device. In particular, FIG. 4 shows an input display wherein a user is prompted to enter various and exemplary candidate user profile information.

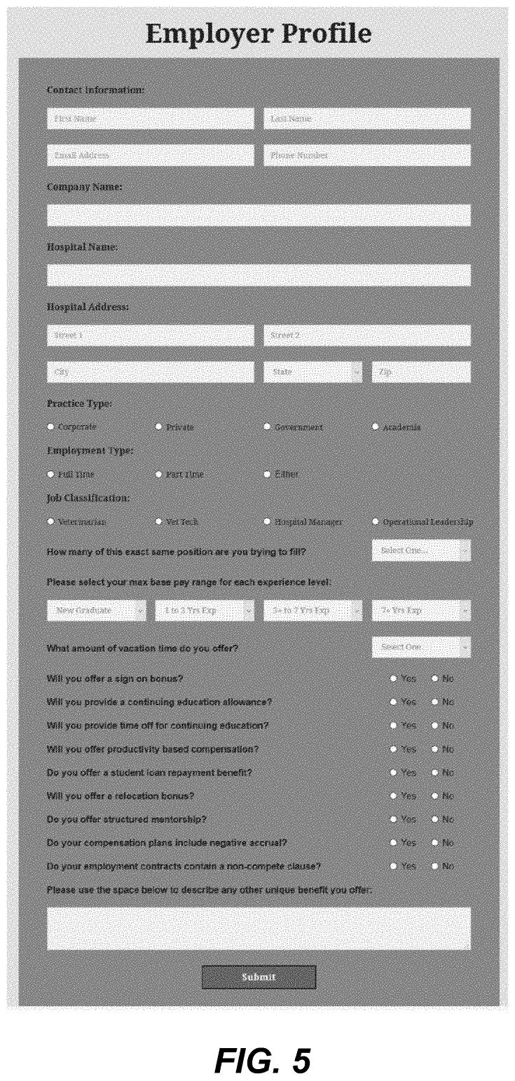

FIG. 5 shows a screenshot of a display at a hiring party user device. In particular, FIG. 5 shows an input display wherein a user is prompted to enter various and exemplary hiring party user profile information.

For example, a hiring party device may be provided a user interface and associated module(s) configured for operating with the system and central server in networked electronic communication. The hiring party device may thus be configured to present one or more displays to the hiring party user at the hiring party user device to create an account or log in to an account as either a job seeker or a hiring party/employer. The hiring party device be configured to interrogate the user by displaying questions that prompt user input for communication to and processing and storage by the central server. For example, the user device may be configured to prompt the hiring party user to enter employer profile information, job postings, and/or hiring requirements and preferences including compensation information and geographical location requirements.

The user device may be configured to present to the user of the device a “main” feed by which candidates matched by the system at the central server within a first threshold different than a second threshold are presented. The user device may be configured to notify the hiring party user of matches, present selectable options for viewing more profile information about a match, or to electronically notify the matched candidate of interest through the system.

The user interface of the candidate device may show similar display features and interrogate the user to harvest profile information for communicating to the central server, and to receive match information and employer contact or messaging from the central server. The central server may hide the identity of the candidate or hiring party. For example, a unique identifier may be assigned by the profile module(s) or the match module for appending to an electronic communication to be transmitted to the user device(s) for providing match information. Systems may be configured to reveal a candidate or hiring party identity at any desired point in the matching process, or the negotiation process. Accordingly, during desired points during a candidate/employer search and/or negotiation process, anonymity may be maintained, enhancing process efficiency and results.

In an embodiment, the system may be configured to facilitate an electronic virtual meeting room or “chat” room. The user device may be caused to display an employer's offer to a candidate. The offer may be communicated through the system from the hiring party user device during, or to initiate, a chat session.

Accordingly, and by example, using embodiments disclosed herein, job seekers and employers may begin the process by registering, creating a user identity and establishing a password. Once the log-in information is established, a user may be prompted to complete the appropriate profile. Once the profile is completed, the user may then be granted access to their dashboards where they will see the match feed, the discovery feed, and the messaging platform.

In an embodiment, the system is configured to search both employer and candidate profile data to determine which jobs/candidates will be presented to users, for example, by presentation “feeds” at remotely located user devices. For example, match feed results presented at a user device may include those candidates and employers whose profile data (compensation and location) matches at a high pre-determined level. Discovery feed results presented at a user device may include all employers and candidates whose profiles do not meet the threshold for the match feed. Either party can express interest in the other. Once that interest is indicated, the other party will be notified. If the interest is mutual, the parties can begin the “Negotiation” process.

In an embodiment, the negotiation process begins with the employer receiving a system generated offer that is determined “Likely to be Accepted.” The software algorithm will generate a recommended offer to the employer based on the information provided in both profiles, and in some embodiments, information from third party databases or other local databases. The employer will be able to adjust any offer component or simply accept the system recommended offer.

In an embodiment, once the system-generated or employer-modified offer is submitted, the candidate will be notified of an offer. The candidate will then be able to accept the offer, decline the offer or adjust any of the offer components. If accepted, the employer will be notified and both will be able to continue communicating in the messaging platform to arrange calls, interviews and/or platform-supported messaging. If declined, the process ends there after user feedback is entered. If the candidate adjusts any component of the offer, they will have to submit their “Counter Offer.” Once submitted, the employer will be notified of a counter offer. The employer can accept it, or adjust it again and re-send their “Final Offer.” After a final offer is submitted, the candidate will be notified of a final offer. The candidate will be able to decline or accept. If they decline the process ends after feedback is provided. If accepted, the employer will be notified and both will continue communicating in the messaging platform to coordinate calls/interviews.

The conventional recruiting process is not transparent, inherently giving more leverage to employers, and placing significant amounts of time at risk for both parties. Systems, apparatus, and methods of embodiments enable candidates to be empowered to determine their own professional value and match with employers who meet their pre-determined offer criteria. For example, if the user's entered criteria does not match at a specified level, candidates and employers can, in some embodiments, receive instant feedback through feeds at a user device where they can view which criteria needs to be adjusted to ensure a closer match. Once a match is made, in some embodiments, as discussed above, the system facilitates semi-automated and electronic negotiation.

Addressing compensation as the first step in a job search process increases the likelihood that candidates and employers will find a successful match and guarantees neither will waste time in a lengthy and unproductive recruiting cycle. Candidates can be themselves throughout the hiring process without the added pressure of trying to impress hiring managers in an attempt to receive a better offer thereby enabling employers and candidates to better assess the job fit.

It has been found that the average offer acceptance rate in skilled talent recruiting is about 60% to 65%. It has further been found that, using an actual prototype of a system in accordance with embodiments of the disclosure has unexpectedly resulted in a far higher average acceptance rate of 98%.

By way of further example, it has been found that the average time to hire (from when a candidate is presented to when the final offer is signed) for veterinarians, human health physicians (excluding credentialing) and other skilled talent classifications is approximately 4-8 weeks. It has been found that, using an actual prototype of a system in accordance with embodiments of the disclosure has unexpectedly resulted in an average time to hire of 2-3 weeks.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

It will be appreciated that the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

Embodiments are shown by way of example, and not by way of limitation in the figures and drawings. While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computerized system useful for machine based matching of job candidates to hiring party requirements, comprising:
a processor associated with a central server configured for networked communication with remotely located user devices;
a hiring party profile database;
a hiring party profile module;
a candidate profile database;
a candidate profile modules; and
a match module configured to match job candidates based on candidate profile information electronically stored in the candidate profile database.

2. The system of claim 1, wherein a first candidate profile information is stored in the candidate profile database, and wherein a second candidate profile information is stored in the candidate profile database.

3. The system of claim 1, the candidate profile information comprising compensation information input by a candidate user at a first remotely located user device, and electronically formatted and communicated to the central server, wherein the candidate profile module automatically processes the electronically formatted and communicated compensation information and stores said automatically processed compensation information in the candidate profile database.

4. The system of claim 3, the candidate profile information comprising compensation information input by a candidate user at a second remotely located user device, and electronically formatted and communicated to the central server, wherein the candidate profile module automatically processes the electronically formatted and communicated compensation information and stores said automatically processed compensation information in the candidate profile database.

5. The system of claim 2, the match module further comprising being configured to match the first candidate user based on hiring party information electronically communicated from a hiring party user device by the central server and automatically processed by the processor and the hiring party profile module, and stored in the hiring party profile database.

6. The system of claim 1, the hiring party profile module further comprising being configured to automatically, with the processor, extract hiring party profile information from an electronically formatted communication from a hiring party user device received by the central server.

7. The system of claim 6, the hiring party profile information further comprising compensation requirements or target compensation parameters.

8. The system of claim 7, the match module further comprising being configured to match a candidate user by processing, using the processor, the stored candidate profile information and the stored hiring party profile information to determine a match for the candidate.

9. The system of claim 7, the match module further comprising being configured to match a candidate user to a hiring party by processing, using the processor, the stored candidate profile information and the stored hiring party profile information to determine whether the candidate match the hiring party based on hiring party requirements.

10. The system of claim 1, the central server and the match module further comprising being configured to select and electronically communicate candidate information based on candidate match information stored in the match database.

11. A method useful for machine based matching of job candidates to hiring party requirements, comprising:
providing a user input portal a job candidate user device configured to communicate with a a central server;
receiving at the central server an electronic communication from the candidate user device;
automatically processing the electronic communication using a processor and a candidate profile module to extract user profile information, the user profile information comprising compensation information;
automatically electronically storing the extracted user profile information comprising the compensation information in a candidate profile database; and
comparing the user profile information comprising the compensation information with hiring party profile information, the hiring party profile information comprising target compensation requirement(s), to match the candidate associated with the user profile information to the hiring party based on the hiring party profile information.

12. The method of claim 11, comprising:
electronically storing the determined match in a match database using the processor and the match module.

13. The method of claim 12, comprising:
electronically communicating the determined match stored in the match database to a hiring party user device from the central server.

14. The method of claim 11, comprising:
receiving at the central server hiring party profile information, the hiring party profile information comprising target compensation requirements for comparing with compensation information of a stored candidate user profile information.

15. The method of claim 11, comprising:
receiving at the central server a second candidate user profile information electronically communicated from a second candidate user device.

16. The method of claim 15, comprising:
automatically processing the second candidate user profile information communicated from the second candidate user device using the processor and the candidate user profile module.

17. The method of claim 11, the candidate user profile information further comprising geographic location information corresponding to residence or work location.

18. The method of claim 11, the hiring party user profile information further comprising geographical location requirements, comprising location of residence and/or required location of work.

19. The system of claim 1, comprising:
a negotiation module configured to determine a proposed compensation offer or counter-offer by a hiring party or by a candidate using the system, wherein the negotiation module caused electronic communication of the proposed compensation offer to the candidate user device or the hiring party user device for display thereon.

20. The method of claim 11, comprising:
determining, using a negotation module and the processor, a proposed compensation offer or counter-offer by a hiring party or by a candidate using the system, wherein the negotation module caused electronic communication of the proposed compensation offer to the candidate user device or the hiring party user device for display thereon, wherein the proposed compensation offer is based on at least one factor selected from the group including: hiring party hiring requirements, candidate compensation requirements, third party compensation information located at third party databases, additional information retrieved from local area networked database; and
electronically communicating the proposed compensation offer to the candidate user device or the hiring party user device.
